(19) United States
(12) Patent Application Publication
(10) Pub. No.: US 2005/0018947 A1
(43) Pub. Date: Jan. 27, 2005

(54) Arrayed waveguide interferometer

(76) Inventor: Zhiyang Li, Hubei (CN)

Correspondence Address: Judson K. Champlin;Westman Champlin & Kelly, Suite 1600-International Centre, 900 Second Avenue South, Minneapolis, MN, 55402-3319, US

(21) Appl. No.: 10/478,135

(22) PCT Filed: May 20, 2002
(86) PCT No.: PCT/CN02/00340

(30) Foreign Application Priority Data
May 25, 2001 (CN) 01114223.5

(51) Int. Cl. G02B 6/12

(52) U.S. Cl. 385/14

(57) ABSTRACT

The invention relates to an arrayed waveguide interferometer, which can be used as core components for optical communication network, optical information transmission, spectrum measurement, sensors, laser devices or integrated photoelectric devices. The arrayed waveguide interferometer includes an input-waveguide, an output-waveguide and a waveguide-array which acts as a coupling component between the input-waveguide and the output-waveguide. All of the optical waveguides are formed in a corporeal carrier, and haves straight-line shape and/or curve shape.

### FIELD OF INVENTION

The present invention relates to optical waveguide devices, in particular, to arrayed waveguide interferometer used as core components in optical communication network, optical information transmission and processing system, optical spectrum analyzing devices, sensing devices, laser devices, integrated opto-electronic devices and the like.

### BACKGROUND OF THE INVENTION

Conventional interferometer includes Fabry-Perot interferometer, Mach-Zehnder interferometer, Michelson interferometer and so on which have been wildly used in various technical fields such as spectrum analysis, laser devices, precise measurement, and photoelasticity analysis. A lot of fiber sensors such as fiber-stress-sensor, fiber-strain-sensor, fiber-temperature-sensor, fiber-magnetic-field-sensor and the like also use sensibility-enhanced fiber as a part of above mentioned interferometer to carry out sensing. In recent years, as the development of optical communication network, there exists the need to various active and passive optical components, such as wavelength demultiplexer/multiplexer (WDMUX/WMUX), wavelength-selective switches (WSS), wavelength-selective router (WSR), wavelength-selective coupler (WSC), wavelength add/drop multiplexer (WADM), optical isolator, narrow band high-stable laser, etc. However, above applications have strict requirements to a lot of parameters such as channel space, the number of total channels, insertion loss, return loss, degree of channel isolation, size of components and compatibility with fibers and the like. Conventional interferometers could not sufficiently satisfy those requirements. For example, the wavelength demultiplexer made of Fabry-Perot interferometer may achieve very high wavelength resolution because it depends on multi-beam interference. However, one demultiplexer of above described type corresponds to only one channel. The degree of integration of this type of wavelength demultiplexer is low and the insertion loss is relatively high. As waveguide Mach-Zehnder interferometer and Michelson. Interferometer employ double-beam interference, their wavelength resolutions are low. The multiplexer/demultiplexer made of waveguide Mach-Zehnder interferometer need a channel space of more than 10 nm, which confines its use in double wavelength system or systems with large channel space. Further, if multilayer interference filters are made to achieve the effect of narrow band filter that meet the requirements of optical communication network, such a filter will suffer the disadvantages of complex structure, high cost, large size and low integration. Therefore, the number of channels will be limited. Above disadvantages limit the application of conventional interferometers in optical communication. Thus, a lot of new components, for example, arrayed waveguide grating (AWG), fiber Bragg-grating (FBG) and the like, have been developed for optical communication network. Among these new components, AWG generates optical path difference by means of waveguide-array so that optical waves having different wavelength may separately diffract in space and then couple into different channels. However, AWG does not have a modularized structure although it can contain more number of optical channels. FBG periodically modulates its refractive index along the axial direction of the fiber and generates Bragg-reflection. FBG is a narrow stop band filter or a narrow band reflector and has a modularized structure. Only one FBG is added if the adding of one channel is needed. However, such a FBG have to be manufactured with special processing technique so as to modulate its refractive index.

### SUMMARY OF THE INVENTION

The present invention has been developed to overcome above disadvantages in prior art. It is therefore an object of the present invention to provide an arrayed waveguide interferometer which is capable of constructing various optical network devices, sensing devices, optical spectrum measuring instruments, laser devices, integrated opto-electronic devices and the like so that the problem of building narrow band waveguide-type interferometers can be solved.

To achieve above object, according to an aspect of the present invention, an arrayed waveguide interferometer comprises an input-waveguide, an output-waveguide, and a waveguide-array which acts as a coupling component between the input-waveguide and the output-waveguide, wherein said waveguide-array composed of at least two optical waveguides and formed on a carrier, and said carrier is a plane substrate.

Preferably, the optical path difference of optical waves which are input from the input end of the input-waveguide and reach the output end of the output-waveguide via two adjacent optical waveguides in the waveguide-array is a multiple of the wavelength of the optical wave to be output from the output-waveguide.

Preferably, the optical path difference of optical waves which are input from the input end of the input-waveguide and reach the output end of the output-waveguide via two adjacent optical waveguides in the waveguide-array is an integral multiple of the wavelength of the optical wave to be output from the output-waveguide.

Preferably, the optical waveguides in the waveguide-array, the input-waveguide, and the output-waveguide are straight-line type of optical waveguides, and the range of the crossing angle between the input-waveguide and output-waveguide is from 0 to 180 degree. Preferably, the optical waveguides in the waveguide-array are curve type of optical waveguides, and the input-waveguide and the output-waveguide are straight-line type of optical waveguides, and the range of the crossing angle between the input-waveguide and output-waveguide is from 0 to 360 degree. Preferably, parts of the optical waveguides in the waveguide-array, the input-waveguide, and the output-waveguide are straight-line type of optical waveguides and the other parts are curve type of optical waveguides.

Preferably, all the optical waveguides in the waveguide-array, the input-waveguide, and the output-waveguide are curve type of optical waveguides

The carrier may be a three-dimensional structure.

Next, the principle of the present invention will be described. Optical waves in the input-waveguide are coupled to the output-waveguide by means of the waveguide-array that consists at least two optical waveguides. Each optical waveguide in the waveguide-array introduces a certain optical path difference. Therefore, all beams of optical waves are interferentially overlapped in the output-waveguide. Only the optical wave of which wavelength meet a certain conditions can generate constructive interference, and comes out from the output-waveguides. Therefore, this kind of interferometer is called as arrayed waveguide interferometer (AWI) based on such a structure characteristic. Unlike AWG, the arrayed waveguide interferometers according to the present invention depends on multi-beam interference, but not multi-beam diffraction. The arrayed waveguide interferometers of the present invention can achieve very high wavelength resolution due to multi-beam interference. The wavelength resolution of the arrayed waveguide interferometers may typically be 1/n of the output center wavelength, where n is the number of optical waveguides contained in the waveguide-array. In the case where the output center wavelength is 1500 nm, the number of optical waveguides contained in the waveguide-array typically is 10,000 so as to obtain a wavelength resolution of 0.15 nm.

The arrayed waveguide interferometer according to the present invention provides following advantages and effects in comparison to the prior art.

The arrayed waveguide interferometers of the present invention use multi-beam interference such that the interferometers can obtain very high wavelength resolution and very narrow channels space. Further, modularization structure is achieved such that only one module is added if the adding of one channel is needed. For the same device, insertion loss due to interfaces between components does not increase as the number of the channel increases. Furthermore, the arrayed waveguide interferometers of the present invention can be used to constitute various optical network devices, sensors, and measuring instruments, such as optical wave multiplexers/demultiplexers, optical switches, couplers, routers, optical isolators, optical spectrum analyzer, sensors, and reflectors. The arrayed waveguide interferometers can be volume produced by using of optical mask technique used in large scale integrated circuit, thereby reducing the size and ensuring good repeatability.

### BRIEF DESCRIPTION OF THE DRAWINGS

The above and other objects, features, and advantages of the present invention will become apparent from the following description with reference to the accompanying drawings, which illustrate examples of the present invention.

FIG. 1 is a diagram showing the arrayed waveguide interferometer according to first embodiment of the present invention, in which the carrier is a plane substrate, and the optical waveguides in the waveguide-array, the input-waveguide, and the output-waveguide are straight-line type of optical waveguides;

FIG. 2 is a diagram showing the arrayed waveguide interferometer according to second embodiment of the present invention, in which the carrier is a plane substrate, and the optical waveguides in the waveguide-array are curve type of waveguides, the input-waveguide and the output-waveguide are straight-line type of optical waveguides;

FIG. 3 is a diagram showing the arrayed waveguide interferometer according to third embodiment of the present invention, in which the carrier is a plane substrate, and the optical waveguides in the waveguide-array, the input waveguide and the output waveguide are partly curve type of waveguides and partly straight-line type of optical waveguides; and

FIG. 4 is a diagram showing the arrayed waveguide interferometer according to fourth embodiment of the present invention, in which the carrier is a plane substrate, and the optical wave guides in the waveguide-array, the input-waveguide and the output-waveguide are curve type of waveguides.

### DETAILED DESCRIPTION OF THE PREFERRED EMBODIMENTS

Referring now to the accompanying drawings, there are shown preferred embodiments of the arrayed waveguide interferometers according to the invention.

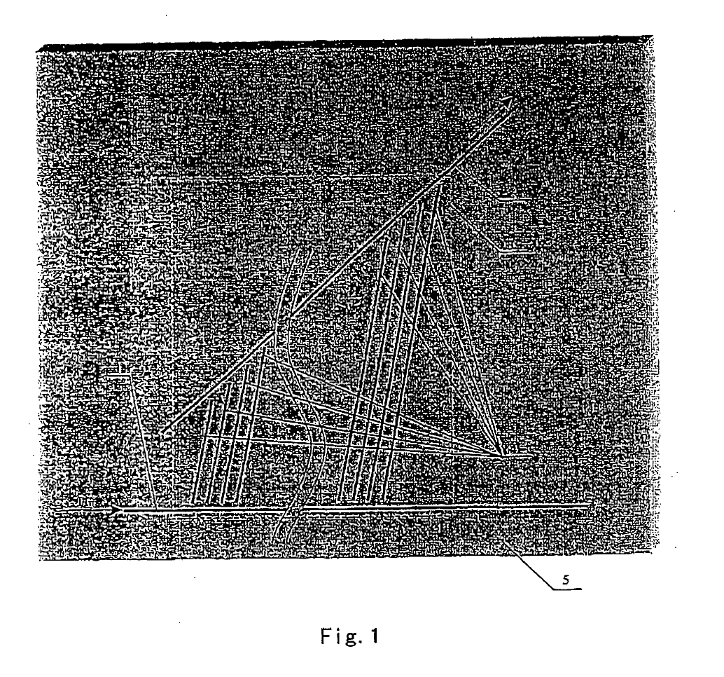

Referring to FIG. 1 showing the first embodiment of the invention, the arrayed waveguide interferometer comprises an input-waveguide 1, an output-waveguide 2, and a waveguide-array 3 coupling the input-waveguide 1 and the output-waveguide 2. The waveguide-array 3 is composed of at least two optical waveguides 4. The waveguide-array 3 couples the optical field in the input-waveguide 1 to the output-waveguide 2, where optical fields coupled by different optical waveguides 4 interferentially overlap. In FIG. 1, Iᵢₙ represents the input optical field, Iₒᵤₜ represents the output optical field. To achieve constructive interference, the optical path difference of optical waves which are input from the left input end of the input-waveguide 1 and reach the right output end of the output-waveguide 2 via two adjacent optical waveguides 4 in the waveguide-array 3 should be a integral multiple of the wavelength of the optical wave to be output from the output-waveguide. The optical path differences of part of the optical waves passing through two adjacent optical waveguides 4 in the waveguide-array 3 may deviate from the integral multiple of the wavelength of the optical wave to be output from the output-waveguide to improve the whole performance, for example, to suppress the second maximal spectrum peak.

Further, the arrayed waveguide interferometer is a kind of device having directionality. Generally, the optical path differences are different when they reach the right output end of the output-waveguide 2 if the optical waves are input from the left input end and right input end of the input-waveguide 1 respectively. This means that if an optical wave having wavelength λ and inputted from the left input end of the input-waveguide 1 can be coupled to the output-waveguide 2 satisfying constructive interference condition, then the optical wave having the same wavelength λ and inputted from right input end of the input-waveguide 1 may not satisfy constructive interference condition when coupled to the output-waveguide 2. In the procedure in which optical wave is input from the input end of the input-waveguide 1, then passes through the waveguide-array 3 and reaches the output of the output waveguide 2, we define the angle which the optical wave vector is rotated as the crossing angle between the input-waveguide 1 and output-waveguide 2. As shown in FIG. 1, the crossing angle between the input-waveguide 1 and output-waveguide 2 is a sharp angle when the optical wave is input from the left input end of the input waveguide. The crossing angle between the input-waveguide 1 and output-waveguide 2 is an obtuse angle when the optical wave is input from the right input end of the input-waveguide 1. Therefore, the range of the crossing angle between the input-waveguide 1 and output-waveguide 2 is from 0 degree to 180 degree when the input-waveguide 1, output-waveguide 2 and the optical waveguides 4 in the waveguide-array 3 are of straight-line shape.

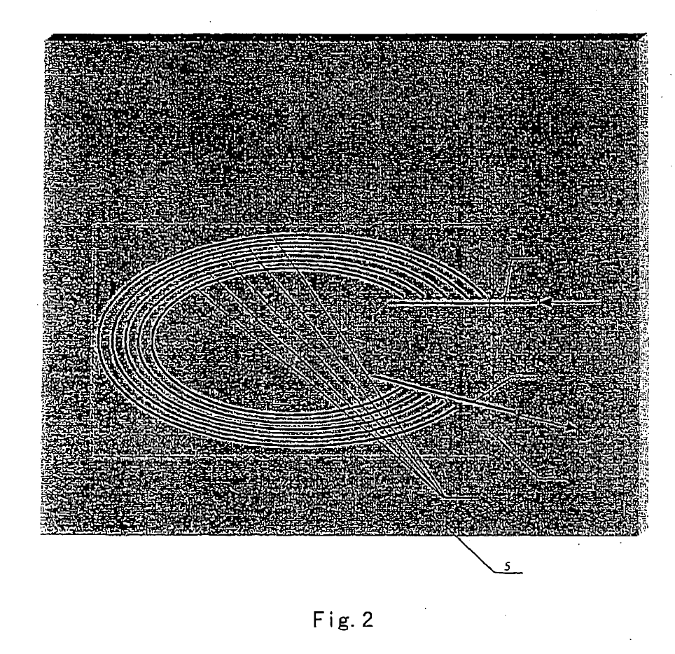

FIG. 2 illustrates the second embodiment of the arrayed waveguide interferometer according to the invention. The optical waveguides 4 in waveguide-array 3 have curve shape while the input-waveguide 1 and output-waveguide 2 have straight-line shape, as shown in FIG. 2. The range of the crossing angle between the input-waveguide 1 and output-waveguide 2 is from 0 degree to 360 degree. In general, a large crossing angle is propitious to increase the path difference between the optical waves that pass through two adjacent waveguides 4 in the waveguide-array 3, and may have the benefit to reduce device size.

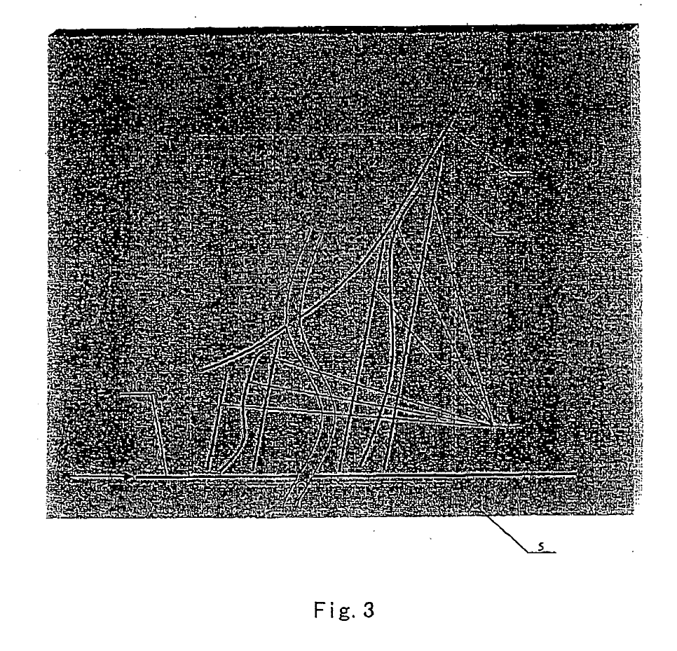

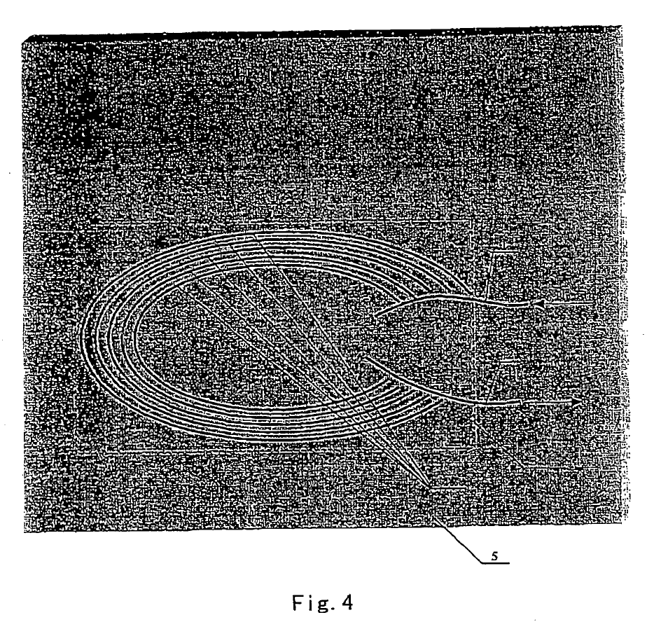

The arrayed waveguide interferometer illustrated in FIGS. 3 and 4 employed curve type of optical waveguides. Although the optical waveguides having straight-line shape facilitate the design, curve shaped optical waveguides facilitate, on one hand, the adjustment of the optical path difference, on the other hand, the adjustment of coupling efficiency of waveguide 4 in waveguide-array 3 to input-waveguide 1 and output-waveguide 2 respectively.

An arrayed waveguide interferometer is equivalent to a narrow band filter with high resolution. The filter characteristic curve depends upon the length, relative position and refraction index of employed optical waveguides. The center wavelength, the positions of second maximal spectrum peak and minimal spectrum peak may be determined by controlling the optical path difference between adjacent waveguides 4. The height and width at half maximum of spectrum characteristic curve can be adjusted by changing the number of optical waveguides 4 in waveguides-array 3 and the coupling intensity between optical waveguides 4 and input-waveguide 1 and output-waveguide 2 respectively, which, on the other hand, can be accomplished by changing their relative positions, such as their gap-widths, and sectional dimensions. In the case where two-dimensional waveguides are used, the input-waveguide 1, the output-waveguide 2 and the waveguides-array 3 can be formed on a plane substrate by using of photo mask technique for manufacturing large scale integrated circuit. In the case where three-dimensional waveguides such as fiber band are used all waveguides can be fixed on a three-dimensional structure. Using of cubical structure can flexibly form the arrayed waveguide interferometer, thereby expanding the application range of the arrayed waveguide interferometer.

In present invention, although one arrayed waveguide interferometer corresponds to only one specific wavelength or channel, arrayed waveguide interferometers corresponding to different channels may be integrated into one device by shareing input-waveguide or output-waveguide. And the insertion loss due to interfaces between different components is eliminated as the number of the integrated arrayed waveguide interferometers increases. In other words, the arrayed waveguide interferometer has modularization structure. Only one modular is added if there is a need to add one channel. A plurality of arrayed waveguide interferometers having different output center wavelength may be integrated, for example, into one device by sharing their output-waveguides to form a wavelength multiplexer. Similarly, a plurality of arrayed waveguide interferometers having different output center wavelength may be integrated into one device by sharing their input-waveguide to form a wavelength demultiplexer. These wavelength multiplexers and demultiplexers can further be utilized to constitut a router. Two or more arrayed waveguide interferometers having same output center wavelength may be integrated along the same input-waveguide. The optical intensities assigned to each of the arrayed waveguide interferometers can be determined based on their arrangement sequence and their coupling intensities with the input-waveguide, thereby forming an optical splitter. An optical reflector can be constituted by combining two arrayed waveguide interferometers having same output center wavelength such that one of the arrayed waveguide interferometer extracts the optical field propagating in forward direction in the input-waveguide and the other arrayed waveguide interferometer couples the extracted optical field back to the input-waveguide, and making it propagating in backward direction. A laser resonance cavity can be formed with two such reflectors. An arrayed-waveguide-interferometer-fiber-laser can be formed by further introducing into the cavity a segment of fiber doped with rare earth element such as Erbium and Nb. An optical isolator can be produced by integrating the arrayed waveguide interferometer in backward direction along the input waveguides, which extracts the optical wave transmitting in backward direction from the input waveguides. In addition by means of external stress, thermo-deformation, piezoelectric effect etc. the optical path difference between adjacent waveguides in the waveguide-array and their coupling intensities with input/output-waveguide can be dynamically changed by adjusting the size, the relative positions of the waveguides in the arrayed waveguide interferometer, or by varying the refraction index of the waveguides by using of electro-optic effect. Thus, the filter characteristic curve, such as center wavelength, the positions of second maximal and minimal spectrum peak, the height and width at half maximum of spectrum peak can be changed accordingly, which could be utilized to construct various optical network devices, optical spectrum instruments, sensors and the like.

1. An arrayed waveguide interferometer comprising an input-waveguide, an output-waveguide, and a waveguide-array which acts as a coupling component between the input-waveguide and the output-waveguide, wherein said waveguide-array composed of at least two optical waveguides and formed on a carrier, and said carrier is a plane substrate.

2. The arrayed waveguide interferometer according to claim 1, wherein the optical path difference of optical waves which are input from the input end of the input-waveguide and reach the output end of the output waveguide via two adjacent optical waveguides in the waveguide-array is a multiple of the wavelength of the optical wave to be output from the output-waveguide.

3. The arrayed waveguide interferometer according to claim 0.1, wherein the optical path difference of optical waves which_are input from the input end of the input-waveguide and reach the output end of the output-waveguide via two adjacent optical waveguides in the waveguide-array is an integral multiple of the wavelength of the optical wave to be output from the output-waveguide.

4. The arrayed waveguide interferometer according to claim 1, wherein the optical waveguides in the waveguide-array, the input-waveguide, and the output-waveguide are straight-line type of optical waveguides, and the range of the crossing angle between the input-waveguide and output-waveguide is from 0 to 180 degree.

5. The arrayed waveguide interferometer according to claim 1, wherein the optical waveguides in the waveguide-array are curve type of optical waveguides, the input-waveguide and the output-waveguide are straight-line type of optical waveguides, and the range of the crossing angle between the input-waveguide and output-waveguide is from 0 to 360 degree.

6. The arrayed waveguide interferometer according to claim 1, wherein parts of the optical waveguides in the waveguide-array, the input-waveguide, and the output-waveguide are straight-line type of optical waveguides and the other parts are curve type of optical waveguides.

7. The arrayed waveguide interferometer according to claim 1, wherein all the optical waveguides in the waveguide-array, the input-waveguide, and the output-waveguide are curve type of optical waveguides.

8. The arrayed waveguide interferometer according to claim 1, wherein the carrier is a three-dimensional structure.
